(19) United States
(12) Patent Application Publication
(10) Pub. No.: US 2009/0095853 A1
(43) Pub. Date: Apr. 16, 2009

(54) COLLAPSIBLE STAND FOR EDIBLE CONES

(76) Inventors: Emanuel Kivowitz, Brooklyn, NY (US); Nir Adar, Briarcliff Manor, NY (US)

Correspondence Address: FOX ROTHSCHILD LLP;New York, 2000 Market Street, Tenth Floor, Philadelphia, PA, 19103, US

(21) Appl. No.: 12/249,499

(22) Filed: Oct. 10, 2008

Related U.S. Application Data
(60) Provisional application No. 60/978,937, filed on Oct. 10, 2007.

(51) Int. Cl. F16M 11/00

(52) U.S. Cl. 248/174

(57) ABSTRACT

A foldable stand includes tapered sections foldably connected to each other, and a flap for connecting one end of the tapered sections to another end of the tapered sections. The tapered sections include at least one internal section, a first end section foldably connected to an end of the internal sections, and a second end section foldably connected to another end of the internal sections. The flap is used to connect the first end section to the second end section. When folded, the tapered sections form a base with an opening disposed over the base, and the base has a larger area than the opening.

### CROSS-REFERENCE TO RELATED APPLICATIONS

This application claims the benefit of U.S. Provisional Application No. 60/978,937 filed on Oct. 10, 2007, the teachings of which are incorporated herein by reference.

### FIELD OF THE INVENTION

Various embodiments of this invention relate to collapsible stands for cone shaped food vessels, whether savory or sweet.

### BACKGROUND OF THE INVENTION

Edible, elongated cones are popular for the consumption of ice-cream, and have recently gained popularity for the consumption of savory products, such as pizza, deli products and other savory foods, which are typically served in the form of sandwiches, wraps, burritos and tacos. Although popular, such cones are not very convenient for consumers or purveyors when situations call for placing the cone down during it's consumption, as the conical shape prevents the cones from standing without the aid of external support. As any fan of ice cream knows, these cones cannot be supported on trays, countertops or tabletops. Stands for ice cream cones are known and can also be employed for savory cones. Most of such stands, however, are made of heavy materials, take up a lot of storage space, are not disposable or recyclable, are hard to assemble or are fully prefabricated, designed for display, are not easily portable and are costly to manufacture and ship. Accordingly, there is a need for a collapsible stand that would be stable enough to support edible cones but which is also easy to pack, economical to produce and not labor intensive to deploy.

### SUMMARY OF THE INVENTION

Various embodiments of the present invention disclose a foldable stand for a food product. The foldable stand includes a plurality of tapered sections foldably connected to each other, and a flap for connecting one end of the tapered sections to another end of the tapered sections. The plurality of tapered sections includes at least one internal section, a first end section foldably connected to an end of the at least one internal section, and a second end section foldably connected to another end of the at least one internal section. The flap is used to connect the first end section to the second end section. When folded, the tapered sections form a base with an opening disposed over the base, and the base has a larger area than the opening.

In various embodiments, the plurality of tapered sections and the flap are serially connected to each other. In some embodiments the flap may serve as a tongue that is inserted into a slot, and in other embodiments the flap has adhesive to bond to one of the end sections.

In preferred embodiments the tapered sections are triangles with truncated top portions. The truncated top portions have an arcuate shape, and form the opening. In specific embodiments, the at least one internal section is provided by two tapered sections that are foldably connected to each other. The first end section foldably connects to one of the internal sections, and the second end section foldably connects to the other internal section.

In another embodiment, the foldable stand further includes a cone-shaped extension that is removably connected to the top portions of the tapered sections.

### BRIEF DESCRIPTION OF THE DRAWINGS

FIG. 1 illustrates a top view of one embodiment of the cone stand.

FIG. 2 illustrates a deployed stand.

FIG. 3 illustrates a stand that in various stages as it is collapsed.

FIG. 4 illustrates a top view of an embodiment of a collapsible stand having perforations.

FIG. 5 shows another embodiment cone stand.

### DETAILED DESCRIPTION

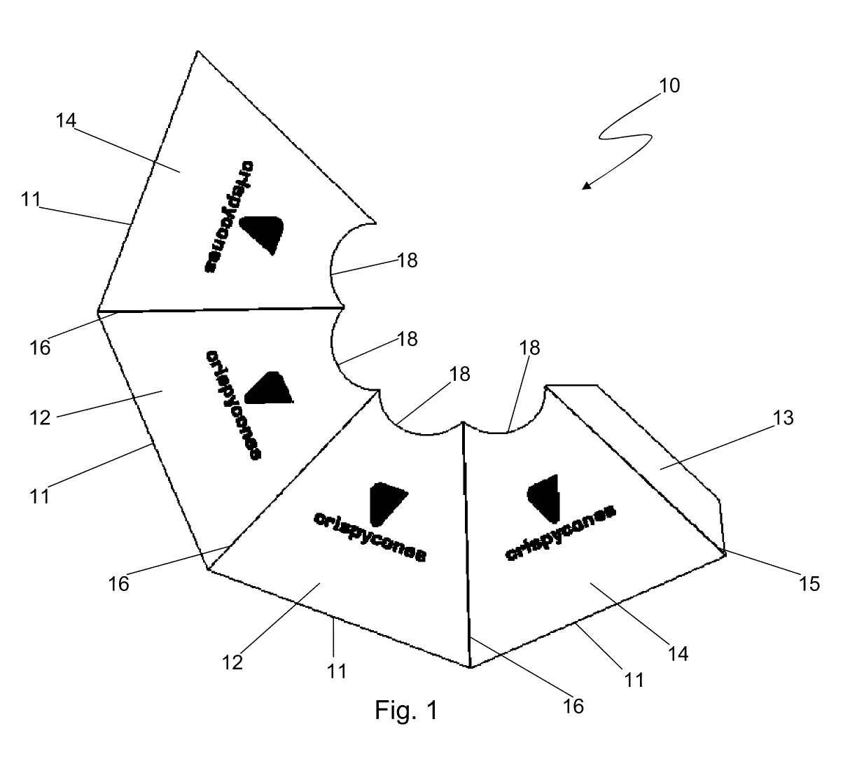

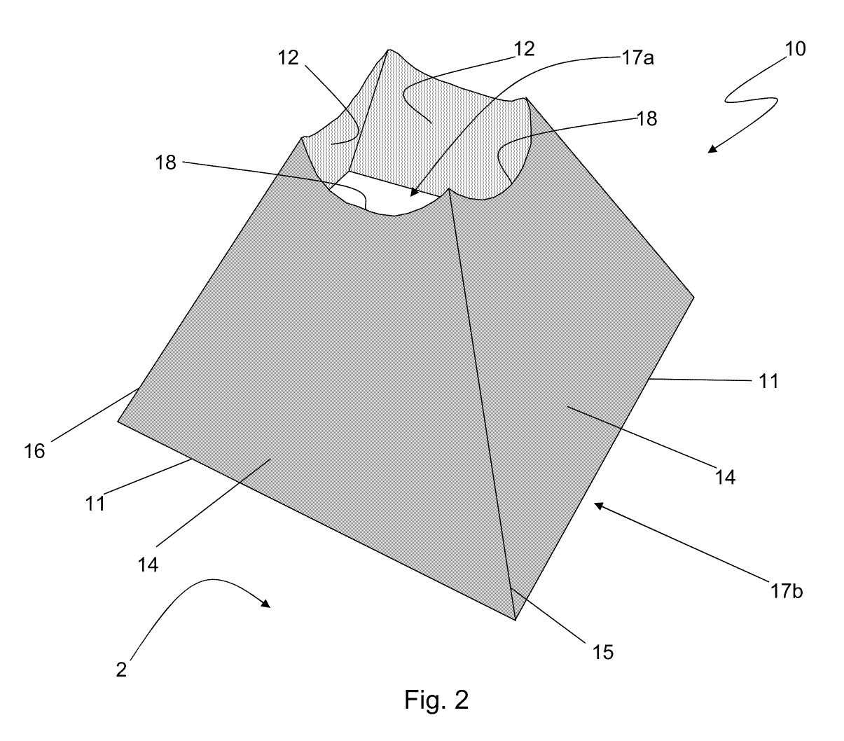

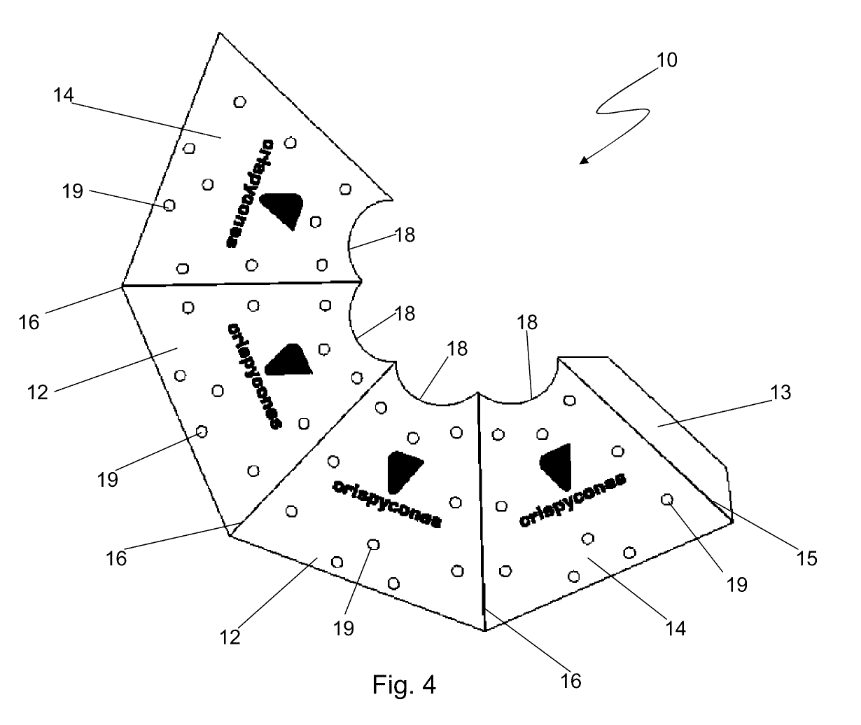

With reference to FIGS. 1-4, a stand 10 comprises a plurality of serially connected tapered sections 12, 14, which in preferred embodiments are truncated triangles 12, 14, wherein the adjacent sections 12, 14 share an edge 16. The sections 12, 14 are tapered so that, when folded, a bottom portions 11 of the sections 12, 14 form a base 17b extending across a larger area than an opening 17a formed by the top portions 18 of the sections 12, 14. The opening 17a is disposed over the base 17b. All triangles 12, 14 are preferably of the same size. There are two outside or end triangles 14 that possess one shared edge 16. The other triangles 12, that is, the internal triangles 12, share edges 16 on two of their respective sides. Thus, one of the end sections 14 connects to one end of the internal sections 12, and the other end section 14 connects to the other end of the internal sections 12. If there is more than one internal section 12, then these internal sections 12 are serially connected to each other, and to the end sections 14, in a foldable manner along their shared sides 16.

In one embodiment, the stand 10 comprises four such truncated triangles 12, 14. The truncation at the top portion 18 of each section 12, 14 is preferably an arcuate truncation 18.

At least one flap 13 may be disposed on a non-shared edge 15 of one of the outside truncated triangles 14. When deploying the stand 10, the flap 13 may be folded inside the stand 10 and the outside of the flap 13 may thus be attached to the inside of the second end triangle 14. The flap 13 may be attached using any suitable adhesive. Preferably, a removable adhesive is used to allow the user to easily disassemble the stand 10 if desired. Alternatively, the flap 13 can be, for example, flanged and used as a tab to be inserted into a slot in the complimentary triangle 14 so that the stand 10 can be assembled by an employee or consumer without the use of adhesive.

The stand 10 can be made of many different materials. The material is preferably heavy enough to ensure that the stand 10 does not collapse under the weight of an edible cone; however the nature of the pyramidal structure 10 provides great strength with relatively light materials. On the other hand, it may be desirable that the material used for the stand 10 is not too heavy to ensure that the stand 10 collapses flat and does not take up too much space during storage or shipment. By way of example, the stand 10 may be made of paper having a weight between 701b and 1001b stock or greater. In such embodiments, the paper may be coated with various commercial food-safe coatings in order to withstand temperatures during heating or chilling. The paper may also be lined with foil or other commercially available materials to strengthen the paper in order to enhance it and facilitate heating in different environments, such as a microwave or standard ovens. In other embodiments, the stand 10 may be made of plastic. Preferably, the plastic is selected to allow the stand to be dishwasher and microwave safe. The plastic may be, for example, between 0.5 and 4 mil thick. In yet other embodiments, the stand 10 may be made of thin sheet metal. In various embodiments the stands 10 may be produced using solid sections 12-14, or with sections 12-14 that are pierced with openings 19 from, for example, 2 mm to 1 cm in size, arranged in various patterns to facilitate air flow and prevent moisture build-up when heating a cone resting in the collapsible stand 10.

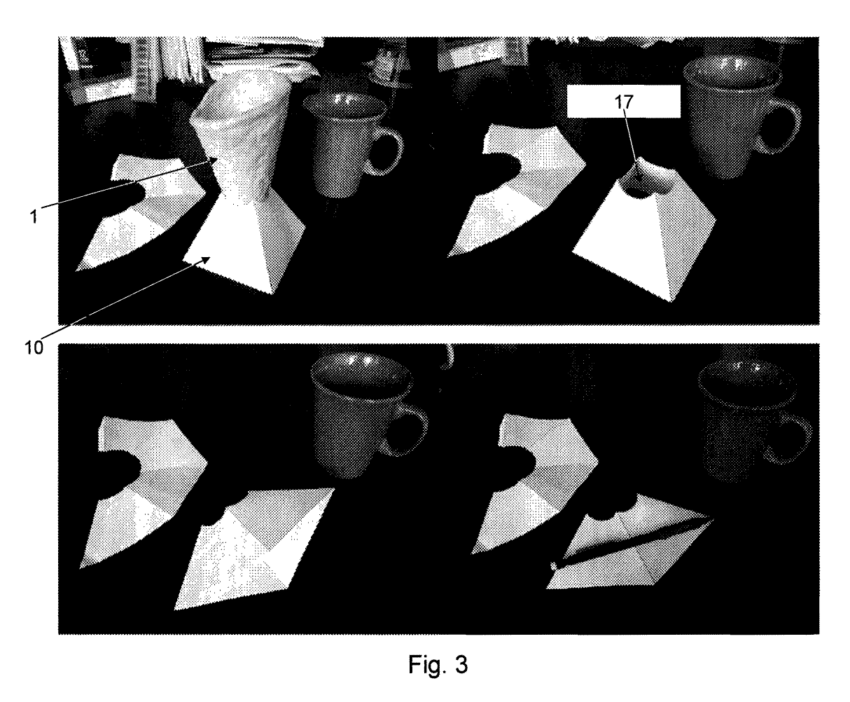

To deploy the stand 10, the flattened, unassembled stand 10 (as illustrated in FIG. 3) may be pressed or folded inward along the opposing shared edges 16, causing the stand 10 to erect from it's flattened state, thereby forming the broader base 17b and the smaller top opening 17a disposed over the base 17b. The shared edges 15, 16 may be marked to show the user how to assemble the stand 10. In some embodiments, especially where heavier materials are employed, the folding edges 15, 16 may be perforated. Once the triangular sections 12, 14 have been bent out of their co-planar configuration and into a pyramidal configuration, the flap 13 may inserted inside the stand 10 so that the outside of the flap 13 attaches to or engages with the inside of the second outside triangle 14. Of course, the flap 13 could also be attached to the outside of the second outside triangle 14, such as by way of adhesives. Any edible cone 1 can then be placed into the opening 17a on top of the stand 10, as shown in FIG. 3.

The physical dimensions of an embodiment collapsible stand 10 may be determined by the degree of taper, diameter and length that the edible cone 1 to be placed in the stand 10 has. In preferred embodiments, the height of the triangular panels 12, 14 and diameter of the top opening 17a are specifically measured so that the bottom of the edible cone 1 remains above the supporting surface 2, preferably a minimum of 0.25″ above the surface 2 that the base 17b of the stand 10 will rest on. This feature is designed to maintain sanitary conditions for the food product 1 by keeping the edible cones 1 from coming into contact with unclean surfaces 2.

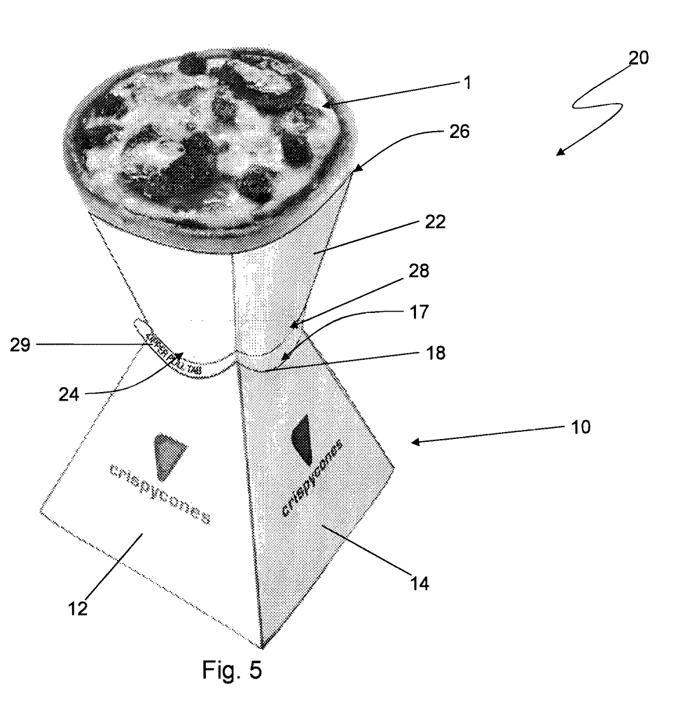

FIG. 5 shows a second embodiment cone stand 20. The cone stand 20 has as a base the cone stand 10 depicted in FIGS. 1-4. A cone-shaped extension 22 is removably attached to the top portions 18 of the sections 12, 14 of the base 10. For purposes of the following, it should be understood that cone-shaped is intended to include conic shapes, but also includes, for example, pyramidal frustums. The cone-shaped extension 22 has a first opening 24 that connects to the opening 17 of the base 10, and a second opening 26 disposed above the first opening 24. The second opening 26 is larger, i.e., has a larger cross-sectional area, than the first opening 24.

In various embodiments, the cone-shaped extension 22 is removably connected to the base 10 by way of a pull-tab 29 or other zipper-like device 29, which connects the top portion 18 of the base 10 to the bottom portion 28 of the cone-shaped extension 22. In other embodiments, the cone-shaped extension 22 is formed integrally with the base 10, and the removable connection 29 is provided by perforations or the like that permit easy tearing away of the cone-shaped extension 22 from the base 10.

The cone-shaped extension 22 may provide a surface on which to apply materials that aid in the crisping of the body of an edible cone 1 when heated, for example, inside a microwave oven. The cone-shaped extension 22, by being removable, may also serve as a sleeve with which a user can hold a heated food product. Additionally, the cone-shaped extension 22 may provide additional support for the edible product 1, making the holding device 20 less likely to tip over.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A foldable stand for a food product, the foldable stand comprising:
a plurality of tapered sections foldably connected to each other, the tapered sections comprising:
at least one internal section;
a first end section foldably connected to an end of the at least one internal section; and
a second end section foldably connected to another end of the at least one internal section; and
a flap for connecting the first end section to the second end section;
wherein when folded the tapered sections form a base and an opening disposed over the base, the base having a larger area than the opening.

2. The foldable stand of claim 1 wherein the plurality of tapered sections are serially connected to each other.

3. The foldable stand of claim 2 wherein a side of the second end section is foldably connected to the at least one internal section and another side of the second end section is foldably connected to the flap; wherein the flap is adapted to connect to the first end section.

4. The foldable stand of claim 3 wherein the first end section comprises a slot adapted to accept the flap.

5. The foldable stand of claim 3 further comprising an adhesive disposed on the flap.

6. The foldable stand of claim 3 wherein the tapered sections are triangles with truncated top portions, the truncated top portions forming the opening.

7. The foldable stand of claim 6 wherein the truncated top portions have an arcuate shape.

8. The foldable stand of claim 7 wherein the at least one internal section comprises two tapered sections foldably connected to each other, the first end section foldably connected to one of the internal sections, the second end section foldably connected to the other internal section.

9. The foldable stand of claim 1 further comprising a cone-shaped extension removably connected to top portions of the tapered sections.
